(19) United States
(12) Patent Application Publication
(10) Pub. No.: US 2023/0042737 A1
(43) Pub. Date: Feb. 9, 2023

(54) TRUSTED, SECURE, AND DEFERRED REAL-TIME PAYMENTS IN A REAL-TIME PAYMENT NETWORK

(71) Applicant: MASTERCARD INTERNATIONAL INCORPORATED, Purchase, NY (US)

(72) Inventors: Irina SINGH, White Plains, NY (US); Andrew BUCKLEY, Kenilworth (GB); Suman RAUSARIA, Chesterfield, MI (US); Shanthan SUBRAMANIAM, Baldwin Place, NY (US)

(21) Appl. No.: 17/869,474

(22) Filed: Jul. 20, 2022

Related U.S. Application Data
(60) Provisional application No. 63/225,377, filed on Jul. 23, 2021.

(51) Int. Cl. G06Q 20/24; H04L 9/40; G06Q 20/38; G06Q 20/10; G06Q 10/08; G06Q 20/42

(52) U.S. Cl. CPC G06Q 20/24; H04L 63/0823; G06Q 20/385; G06Q 20/108; G06Q 10/087; G06Q 20/42

(57) ABSTRACT

The disclosure relates to a deferred real-time payment (RTP) in a trusted and secure system environment to pay for a deferred fulfillment order. The deferred fulfillment order includes products or services that may be fulfilled in part or in full after authorization of the deferred RTP. To facilitate trust and security, a deferred payment system may digitally sign certificates issued to various entities in the system environment. Devices in the system environment may transmit and receive messages to create and later settle deferred RTPs that are trusted based on authentication of the digitally signed certificates, which mitigate against security threats such as man-in-the-middle attacks in a communication network.

### RELATED CASES

This application claims priority to U.S. Provisional Patent Application Ser. No. 63/225,377, filed on Jul. 23, 2021, the content of which is incorporated by reference in its entirety herein.

### BACKGROUND

Deferred fulfillment orders are orders in which products and/or services are partially or fully fulfilled after an initial transaction to acquire the products and/or services. Deferred fulfillment orders may include a partial shipment in which products are delivered or shipped in parts (at different times), such as when they become available to ship. Deferred fulfillment orders may also, or instead, include services that may be performed in parts (at different times), such as according to a service schedule. A consumer may prefer to pay for a deferred fulfillment order as the products and/or services are fulfilled instead of a total amount upfront. Merchants may prefer to receive some assurance that the total amount will be paid upon fulfillment of the products and/or services in the deferred payment order.

Cashless and touchless payments are an increasingly preferred way to pay and may be necessary for electronic commerce-based payments. However, while card payments through a card payment network may facilitate pre-authorization of a total amount and partial settlements from a card account (such as credit card account), doing so via bank account-to-bank account transfers may be challenging. For example, a real-time payment (RTP) network may transfer funds in real-time from a consumer's bank account to a merchant's bank account, but the instantaneous transfer precludes pre-authorization and partial settlements. Thus, while a consumer may use a consumer bank account to instantly pay a merchant through the RTP network, such payment would instantaneously transfer a specified amount from the consumer's bank account rather than at the time of fulfillment, and not incremental based on how much of the deferred fulfillment order was fulfilled. Because of the instant transfer from a bank account to another bank account, trust and security concerns stemming from transactions over a communication network, as well as absence of technology infrastructure, introduce problems for deferred payments through an RTP network. For example, man-in-the-middle attacks may compromise trust and result in stolen credentials when a merchant or merchant processor submits settlement requests. Such stolen credentials may result in the instantaneous withdrawal of funds from a consumer's bank account. Thus, what is needed is a trusted and secure technology infrastructure to facilitate RTP payments via an RTP network for deferred fulfillment orders.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment of trusted deferred real-time payments through a real-time payment network;

FIG. 2 illustrates an example of a method of registering a merchant and generating a digital certificate for a merchant processor the merchant to facilitated trusted communications in the system environment;

FIG. 3 illustrates an example of a method of certificate-based validation of a merchant processor and/or merchant;

FIGS. 4A and 4B illustrate respective data flow diagrams that together show an example process of initiating a deferred RTP in the system environment illustrated in FIG. 1;

FIGS. 5A and 5B together respective data flow diagrams that together show an example process of partially or fully settling the deferred RTP initiated as illustrated in FIG. 2;

FIG. 6 illustrates an example of a method of initiating a real-time payment (RTP) transaction via a RTP network;

FIG. 7 illustrates an example of a method of partially or fully settling a deferred RTP; and

FIG. 8 illustrates an example of a computer system that may be implemented by devices illustrated in FIG. 1.

### DETAILED DESCRIPTION

The disclosure relates to systems and methods that improve trust, security, and ability to defer an RTP via an RTP network in a trusted and secure system environment to pay for a deferred fulfillment order. To facilitate trust, a deferred payment system may digitally sign certificates issued to various entities in the system environment. Devices in the system environment may transmit and receive messages to create and later settle deferred RTPs that are trusted based on authentication of the digitally signed certificates, which mitigate against security threats such as man-in-the-middle attacks in a communication network. The deferred payment system may further improve security by eliminating the need to transmit consumer bank account credentials or merchant settlement account credentials in data transmitted through the deferred payment system.

Having described an overview of various system operations, attention will now turn to a description of an example of a system environment to provide trusted deferred RTPs for deferred fulfillment.

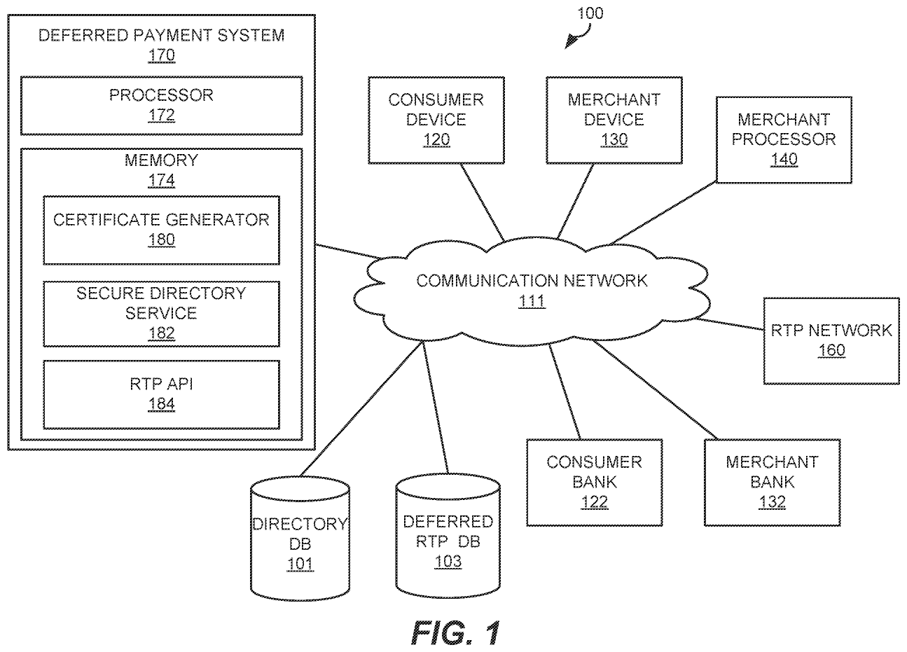

For example, FIG. 1 illustrates an example of a system environment 100 of trusted deferred real-time payments (RTPs) in an RTP network. The system environment 100 may include, among other things, a consumer device 120, a consumer bank 122, a merchant device 130, a merchant bank 132, a merchant processor 140, a certificate authority 150, a real-time payment (RTP) network 160, a deferred payment system (DPS) 170, a directory database 101, a deferred RTP database 103, and/or other components. Examples described herein include a “consumer” making a “purchase” from a “merchant.” It should be understood that in these examples, the “consumer” may refer to any entity that enters into a deferred fulfillment order with a “merchant,” which may refer to any entity that provides the goods and/or services of the deferred fulfillment order in exchange for payment through a deferred RTP.

As used herein, the term real-time payment, or RTP, may refer a payment transaction through the RTP network 160 that results in a real-time and direct transfer of funds from one bank account of a sender to another bank account of a recipient. For example, a consumer may purchase goods or services from a merchant using an account-based payment in which a consumer bank 122 debits an amount from a consumer bank account and transfers the amount to a merchant bank account of a merchant bank 132. This is contrasted from a credit card transaction through a card payment network in which an issuing bank of a credit card transfers credit funds from a credit card account to a merchant account. The term “deferred RTP” may refer to an RTP that is pre-authorized for a total amount and is partially or fully settled through the RTP network 160 as goods and/or services of a deferred fulfillment order are fulfilled.

The consumer device 120 may include a device having processing capabilities such as a laptop computer, “smartphone” device, and/or other device generally operated by a consumer and programmed to initiate and confirm a deferred RTP. For example, a consumer device 120 may be equipped with a banking application that may transmit a consumer alias that is used to identify a consumer bank 122 and a consumer account from or to which to make or receive funds in connection with deferred RTPs.

The consumer bank 122 may refer to a device such as a server of a bank at which the consumer holds the consumer account. The consumer bank 122 may facilitate the transfer of funds to or from the consumer account.

The merchant device 130 may refer to a device of a merchant that initiates payments for a merchant. In the context of electronic commerce (“e-commerce”) transactions, the merchant device 130 may include a device that communicates with a consumer device 120 such as through an e-commerce site. In the context of brick-and-mortar commerce, the merchant device 130 may include a terminal device that may accept deferred RTPs.

The merchant bank 132 may refer to a device such as a server of a bank at which the merchant holds a merchant account. The merchant bank 132 may facilitate the transfer of funds to or from the consumer account.

The merchant processor 140 may refer to device such as a server of an entity that acts on behalf of a merchant to process payments from others such as consumers. The entity operating the merchant processor 140 may include a payment gateway, a merchant processor provider (PSP), or other provider that acts on behalf of the merchant.

The real-time payment (RTP) network 160 may facilitate the transfer of funds between bank accounts in real-time. The term “real-time” refers to an immediate bank account-to-bank account transfer of funds without a delay, unlike other account-based transfers such as Automated Clearing House (ACH) that may have a delay of up to three days or wire transfers that may take up to 24 hours. For example, a real-time transfer from a consumer bank account to a merchant bank account through the RTP network 160 may take milliseconds. The RTP network 160 is therefore different from a card payment network that makes payment from a credit card account (for example).

The DPS 170 may facilitate trusted and secure deferred RTPs. The DPS 170 may include a processor 172, a memory 174, a certificate generator 180, a secure directory service 182, an RTP application programming interface (API) 184, and/or other components. The processor 172 may be a semiconductor-based microprocessor, a central processing unit (CPU), an application specific integrated circuit (ASIC), a field-programmable gate array (FPGA), and/or other suitable hardware device. Although the DPS 170 has been depicted as including a single processor 172, it should be understood that the DPS 170 may include multiple processors, multiple cores, or the like. The memory 174 may be an electronic, magnetic, optical, or other physical storage device that includes or stores executable instructions. The memory 174 may be, for example, Random Access memory (RAM), an Electrically Erasable Programmable Read-Only Memory (EEPROM), a storage device, an optical disc, and the like. The memory 174 may be a non-transitory machine-readable storage medium, where the term “non-transitory” does not encompass transitory propagating signals. The certificate generator 180, the secure directory service 182, and/or the RTP API 184 may each be implemented as instructions that program the processor 172. Alternatively, or additionally, the certificate generator 180, the secure directory service 182, and/or the RTP API 184 may each be implemented in hardware.

The certificate generator 180 may issue digital certificates for identity verification. For example, the certificate generator 180 may issue a digital certificate to a recipient so that the recipient may be later identified as holding the digital certificate. A digital certificate may refer to electronic data that encodes verifiable identity information. For example, among other data, the digital certificate may include a public-private key pair, a recipient identifier that identifies a recipient to whom the digital certificate was issued, and/or other information. One example of a digital certificate that may be used is an X.509 certificate, although other techniques using public-private key cryptography may be used.

The public-private key pair may be used to verify ownership of identity data. For example, the certificate generator 180 may generate a public key and a private key via randomization techniques that generate random numbers. The randomization techniques may include Rivest-Shamir-Adleman (RSA), Digital Signature Algorithm (DSA), Elliptic Curve DSA (ECDSA), and/or other public-private cryptographic techniques.

The random numbers may be generated as a pair such that encryption, or digital signature, using one may be decrypted only by the other. To illustrate, data digitally signed using the private key may be decrypted only by its corresponding public key to obtain the original data, and vice versa. An entity for which a public-private key pair is generated may securely store the private key while the public key is made publicly available to verify that the entity has ownership of the private key. Thus, when the entity digitally signs data with its private key, a recipient of the digitally signed data may verify that the entity has ownership of the private key by successfully decrypting the digitally signed data to produce the original data. If the private key issued to the entity is not used, the digitally signed data may not be decrypted to produce the original data using the corresponding public key. In this manner, through digital signature and decryption using public-private key pairs, an identity of the entity may be verifiable. In some examples, the certificate generator 180 may generate a public-private key pair to digitally sign certificates. For example, the certificate generator 180 may digitally sign each digital certificate it issues to recipients with its private key. Thus, interested parties may authenticate the source of the issuer of the digital certificate using the public key corresponding to the private key of the certificate generator 180. Assuming the certificate generator 180 is trusted, the digital certificate may provide trusted and secure communication between parties. For example, the DPS 170 may trust an identity of a requester (such as the merchant processor 140) using the requester's digital certificate. Similarly, the requester may trust the identity of the DPS 170 using a server certificate of the DPS 170.

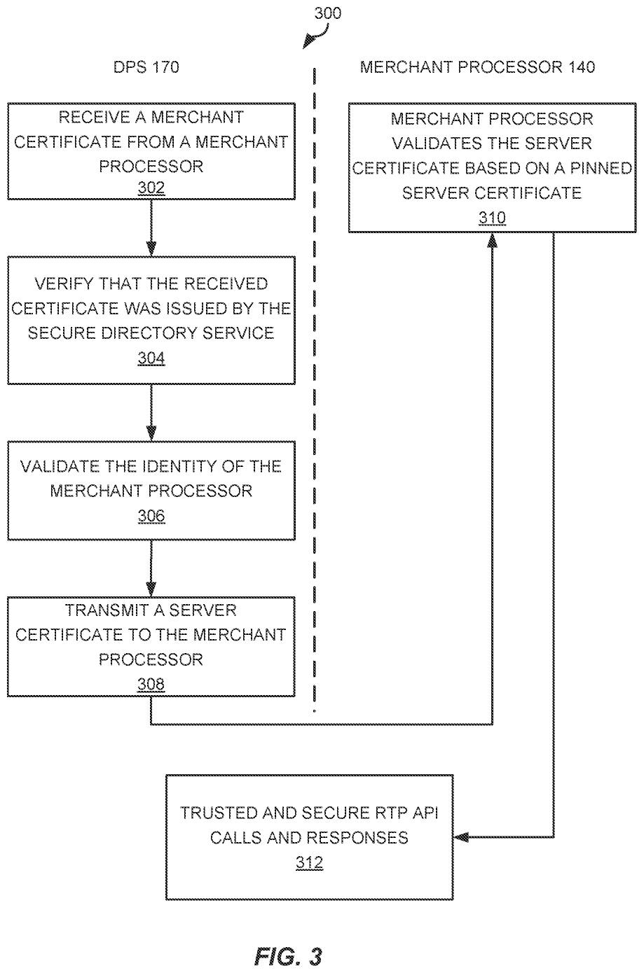

The certificate generator 180 may issue a respective digital certificate to each of various entities in the system environment 100 to provide trusted and secure communication between these entities. For example, the certificate generator 180 may issue a respective digital certificate to a merchant, a merchant processor 140, an operator of the DPS 170, and/or other entities associated with the devices of the system environment 100. It should be noted that validating a device of a recipient of a digital certificate may refer to validating a digital certificate issued to the recipient. An example of validating an entity based on such digital certificate will be described with reference to FIG. 3.

Although illustrated as being part of the DPS 170, the certificate generator 180 may be implemented by a trusted third-party such as a certificate authority. In either instance, the DPS 170 may use the certificate generator 180 to issue digital certificates. In this manner, the DPS 170 may facilitate secure, trusted, communications within the system environment 100 such as the merchant device 130, the merchant processor 140, the consumer bank 122, and/or other participants in the system environment 100.

The secure directory service 182 may register entities associated with various devices of the system environment 100 to provide secure, trusted, communication between the devices. The secure directory service 182 may register an entity in response to the entity's request to participate in deferred RTPs. For example, the secure directory service 182 may register a consumer associated with the consumer device 120, a merchant associated with the merchant device 130, a merchant processor 140 associated with the merchant processor 140, and/or other component of the system environment 100. The secure directory service 182 may store the registered data for each of the entities using data structures illustrated in Tables 1 and 2, which may be stored in the directory database 101. The particular implementation of the directory database 101 may vary, so long as the relationships between and within the data structures are implemented as illustrated in Tables 1 and 2.

To register the consumer, the secure directory service 182 may access a consumer alias, a consumer identifier, a name of a consumer bank 122 at which the consumer has a bank account against which the deferred RTP is to be authorized and settled, and/or other information. The consumer alias and the consumer identifier may each uniquely identify a consumer. Examples of the consumer alias may include an electronic mail address, a phone number, and/or other identifier that may be used to identify the consumer. In some examples, the consumer alias be selected by the consumer or may be assigned to the consumer by the secure directory service 182 or the consumer bank 122. The consumer bank 122 may assign the consumer identifier to the consumer and store the consumer identifier in association with the consumer alias. The consumer bank 122 may also store the consumer's bank account identifier in association with the consumer identifier and/or the consumer alias. When paying a merchant through a deferred RTP, the consumer may input the consumer alias instead of sensitive information that may be stolen such as the consumer's bank account identifier. When the DPS 170 provides the consumer alias and/or the consumer identifier to the consumer bank 122, the consumer bank 122 may internally (based on information stored by the consumer bank) identify the consumer's bank account identifier based on the consumer alias and/or the consumer identifier. In this manner, the bank account identifier remains in the banking domain and is not otherwise exposed in connection with the deferred RTP, improving the security of the system environment 100 to mitigate the risk of stolen information. The secure directory service 182 may generate a data structure to store the data in association with one another.

Table 1. Table 1 illustrates an example of a data structure that the secure directory service 182 may use to store consumer registration information. Only two entries are illustrated for clarity. A consumer ID may be generated by the consumer bank 122 for a given consumer. The consumer or other entity may select a consumer alias that is linked to the consumer bank 122. The consumer bank 122 may also store an association of the consumer ID and the consumer alias. If the consumer alias is selected by the consumer when the consumer registers to use the DPS 170, the DPS 170 may transmit the consumer alias and the consumer ID to the consumer bank 122 so that it may link the consumer alias with the consumer ID, which is linked to the consumer's bank account identifier at the consumer bank 122. It should be noted that the DPS 170 may not have access to the consumer's bank account identifier, improving the security and convenience of using the DPS 170 to facilitate deferred RTPs.

| Consumer ID | Consumer Alias | Consumer Bank |
|---|---|---|
| 12345 | joe[at]example[dot]com | ABC Bank |
| 98765 | 555-555-1234 | 123 Bank |
| . . . | . . . | . . . |

Referring to Table 1, it should be noted that a single consumer may have multiple consumer aliases, multiple consumer banks, and multiple consumer bank account identifiers so long as a given consumer alias is linked to a single preferred bank account identifier so that when the consumer uses a consumer alias, a preferred consumer bank account identifier may be used. Alternatively, if a single consumer alias is linked to multiple consumer bank account identifiers, then the system may prompt the consumer to select a consumer bank and associated consumer bank account identifier to use for the deferred RTP.

In some examples, each merchant processor 140 may be responsible for verifying the identity of the merchants they service and registering their merchants with the DPS 170. If the DPS 170 has not already registered the merchant processor 140, the secure directory service 182 may register and generate a merchant processor identifier for the merchant processor 140.

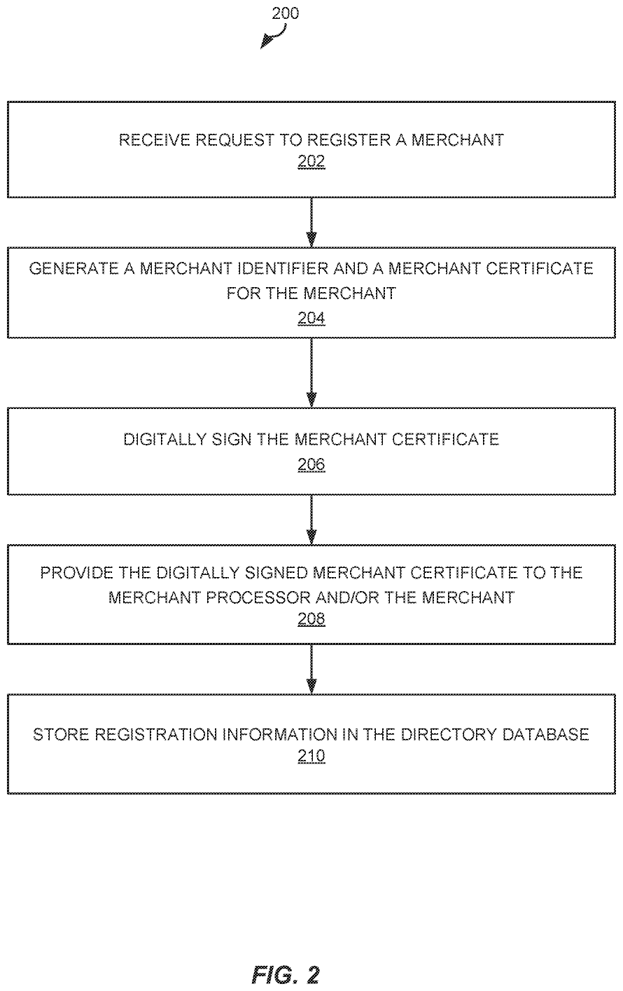

Reference will now be made to FIG. 2, which illustrates an example of a method 200 of registering a merchant and generating a digital certificate for a merchant processor and the merchant to facilitate trusted communications in the system environment 100.

At 202, the method 200 may include receiving a request to register a merchant. For example, the request may be received from a merchant processor 140 responsible for registering the merchant to participate in deferred RTPs. The request may include a merchant name, merchant contact information (such as email and phone number), a merchant location, and bank account credentials such as a bank routing number and account number (receive only) for a merchant bank account.

At 204, the method 200 may include generating a merchant identifier and a digital certificate for the merchant. The digital certificate may identify, as the recipient, the merchant name, merchant processor name, and/or other identifier that identifies the merchant or merchant processor 140. The digital certificate may be generated by the certificate generator 180. Thus, in some examples, the certificate may include a public-private key pair for the merchant processor 140 and/or the merchant. In some examples, a certificate may be generated for the merchant processor 140 and another certificate may be generated for the merchant.

At 206, the method 200 may include digitally signing the certificate and providing the digitally signed certificate to the merchant processor 140 and/or the merchant. The certificate may be digitally signed by a private key of the secure directory service 182. Thus, a recipient (such as the merchant, the merchant processor 140, and the DPS 170) of the certificate may verify that the secure directory service 182 issued the certificate based on the digital signature using the private key of the secure directory service 182.

At 208, the method 200 may include providing the digital certificate to the merchant processor 140 and/or the merchant. The merchant processor 140 and/or the merchant may use the digital certificate to provide trust and non-repudiation.

At 210, the method 200 may include storing the registration details such as the merchant identifier, the merchant name, contact information, merchant location, bank account credentials, the digital certificate, and/or other registration information in the directory database 101.

Table 2 illustrates an example of a data structure that the secure directory service 182 may use to store processor or merchant identity information. Only two entries are illustrated for clarity.

| | Merchant | Settlement | | |
|---|---|---|---|---|
| Merchant ID | Processor ID | Account | Merchant name | Public Key |
| 4321 | 10001 | 12345 | ABC processor | Am139bkl. . . |
| 9876 | 20102 | 54321 | XYX merchant | AAgkow1. . . |
| . . . | | . . . | . . . | |

The issued certificates may be used to provide trusted and secure communications between the merchant processor 140 and/or the merchant device 130 to the DPS 170. For example, FIG. 3 illustrates an example of a method 300 of certificate-based validation of a merchant processor and/or merchant.

At 302, the DPS 170 may receive a digital certificate from the merchant processor 140. For example, the digital certificate may have been issued to the merchant and/or the merchant processor 140 during a registration process illustrated in FIG. 2.

At 304, the DPS 170 may verify that the received certificate was issued by the secure directory service 182 to the merchant processor 140 and/or the merchant. For example, the DPS 170 may decrypt digitally signed data of the received certificate using the public key of the secure directory service 182. If the decrypted and digitally signed data is properly decrypted using the public key of the secure directory service 182, the DPS 170 may determine that received certificate was issued by the secure directory service 182.

At 306, the DPS 170 may validate the identity of the merchant processor 140. For example, the DPS 170 may that the merchant processor 140 has possession of a private key issued to the merchant processor 140 and/or the merchant, thereby validating the identity of the merchant processor 140. In this example, the merchant processor 140 and/or the merchant device 130 may digitally sign the certificate using the private key issued to the merchant processor 140 and/or the merchant device 130 during the registration process. The DPS 170 may decrypt digitally signed data of the received certificate using the public key of the merchant processor 140 and/or the merchant. If the decrypted and digitally signed data is properly decrypted using the public key of the merchant processor 140 and/or the merchant, the DPS 170 may determine that received certificate was issued to the merchant processor 140 and/or the merchant and that the merchant processor 140 therefore has possession of the received certificate.

At 308, the DPS 170 may transmit a server certificate to the merchant processor 140. The server certificate may be digitally signed by the DPS 170 using a private key associated with the DPS 170. The private key may be the same private key used to generate the digital certificate or a different private key, so long as the private key has a corresponding public key that may be used by the merchant processor 140 to validate the server certificate.

At 310, the merchant processor 140 may validate the server certificate to verify the identity of the DPS 170. For example, the merchant processor 140 may decrypt digitally signed data of the server certificate using the public key of the DPS 170. If the decrypted and digitally signed data is properly decrypted using the public key of the DPS 170, the merchant processor 140 may determine that server certificate is authentic. In some examples, the merchant processor 140 and/or the merchant device 130 may pin the server certificate of the DPS 170. Pinning may include storing a trusted version of the server certificate in association with an identifier of the DPS 170 (such as an internet protocol address or other uniquely identifying information). In this way, each time the merchant processor 140 and/or merchant device 130 receives a server certificate from the DPS 170, the merchant processor 140 and/or merchant device 130 may compare the received server certificate with the trusted server certificate.

In some examples, 302-310 may be implemented as a handshake operation in which the merchant processor 140 and the DPS 170 initiate a trusted and secure communication channel which may defend against man-in-the-middle attacks. The trusted and secure communication may be generated based on a Secure Socket Layer (SSL), Transport Layer Security (TLS), and/or other protocol.

At 312, the DPS 170 and the merchant processor 140 may have validated one another and may begin trusted and secure communications. For example, the merchant processor 140 may make trusted and secure API calls provided by the RTP API 176 or other requests or responses to the DPS 170, and vice versa.

Returning now to FIG. 1, the RTP API 176 may provide an interface for entities in the system environment 100 to interface with the DPS 170. The RTP API 176 may be implemented using a RESTful (REST) Application Programming Interface (API), a Simple Object Access Protocol (SOAP) interface, and/or other type of interface that may provide an interface to the DPS 170. The RTP API 176 may expose API calls that entities use to transmit data to the DPS 170 and/or to one another. A given API call may therefore invoke a particular function with one or more parameter input arguments. These parameter input arguments may take, as input, various data. For example, a request or message described herein may be made to or from the DPS 170 via an API call that includes a message with parameter values.

It should be noted that functions of the secure directory service 182 and/or other functions of the DPS 170 may be implemented as API calls provided by the RTP API 176. For example, a function of the DPS 170 described herein may be initiated via an API call to perform that function. Furthermore, the various operations, messages, and requests illustrated in FIGS. 2A, 2B, 3A, 3B, and 4-7 may be made through one or more API calls to the RTP API 176. Alternatively, or additionally, the various operations, messages, and requests may be made through messages formatted according to an RTP message format used by the RTP network 160 or a ISO8583 message format.

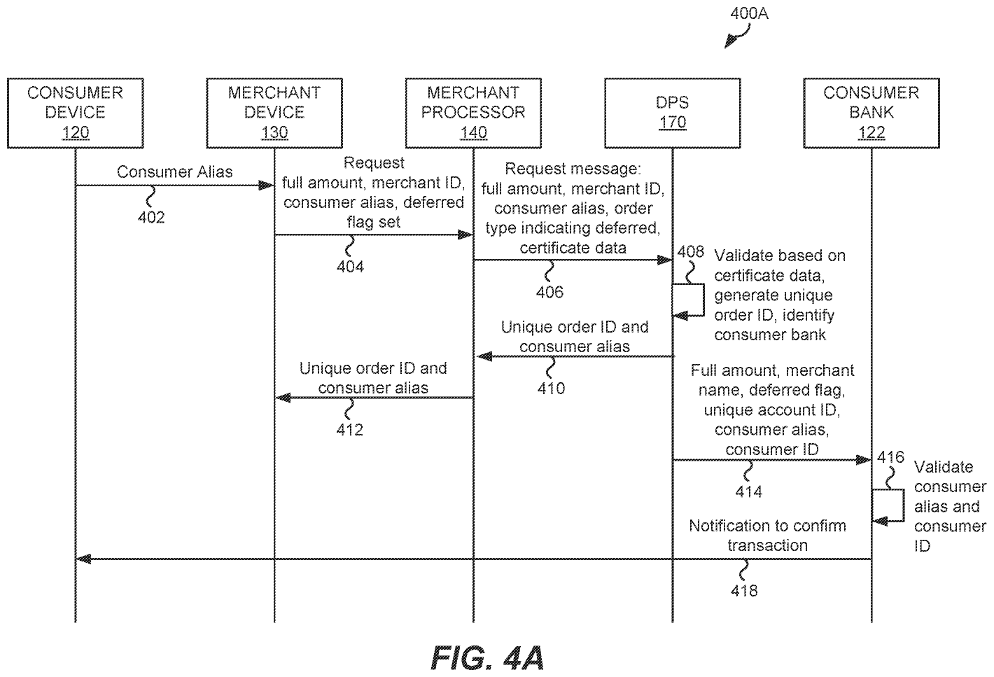

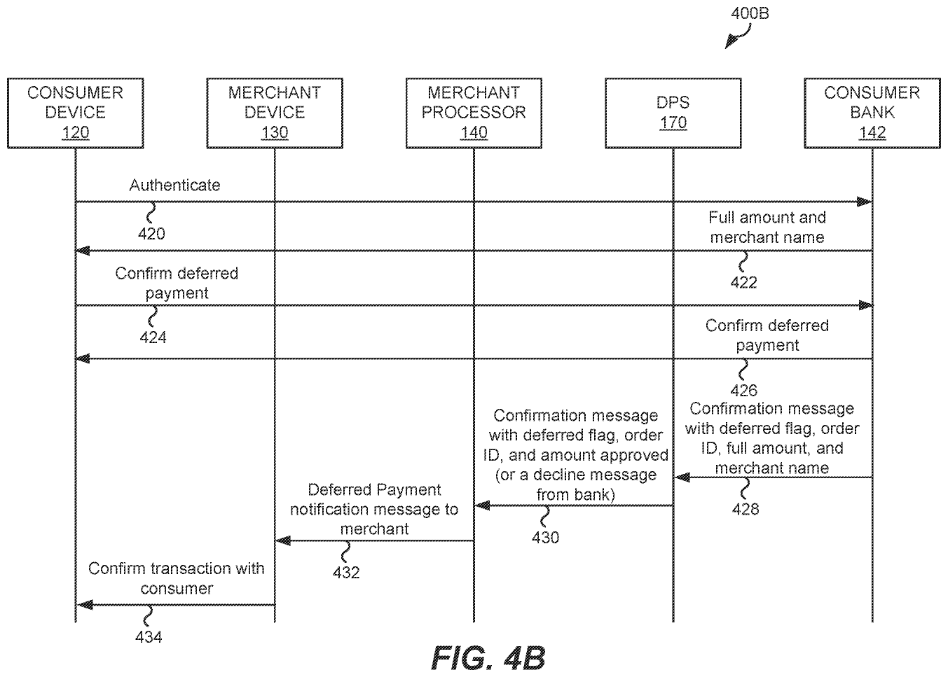

Having described examples of components of the system environment 100, attention will be turned to data flow diagrams that together show an example process of initiating a deferred RTP in the system environment 100. For example, FIGS. 4A and 4B illustrate respective data flow diagrams 200A and 200B that together show an example process of initiating a deferred RTP in the system environment 100.

Referring to FIG. 4A, at 402, in connection with a deferred fulfillment order, the consumer device 120 may transmit a consumer alias to merchant device 130 to initiate a deferred RTP. For example, in online transactions using the consumer device 120, a consumer may input the consumer alias into a checkout page of an e-commerce site of the merchant. In another example, a consumer may transmit the consumer alias to the merchant device 130 in a brick-and-mortar establishment of the merchant. In some examples, a consumer may input the consumer alias directly to the merchant device 130 without use of the consumer device 120. In either example, because the consumer alias is provided, actual bank account identification is not transmitted or provided, enhancing security of the deferred RTP.

At 404, the merchant device 130 may transmit, to a merchant processor 140 that facilitates payments on behalf of the merchant, a request to initiate a deferred RTP. The request may include a full amount of the deferred fulfillment order to be paid, a merchant identifier, the consumer alias received from the consumer, and a deferred flag that indicates that the payment is to be deferred. If the deferred flag is not set to indicate deferral, then the total amount is to be paid in full immediately. Examples that follow will assume that the deferred flag is set to indicate that payment is to be deferred.

At 406, responsive to the request from the merchant device 130, the merchant processor 140 may generate a request message that requests the deferred RTP. The request message may encode the full amount, merchant identifier, consumer alias, and an order type that indicates a deferred RTP is to be made. The request message may be received as an API call of the RTP API 126 that initiates processing the request message at the DPS 110. The API call may include arguments that specify the full amount, merchant identifier, consumer alias, and the order type. Other messages and requests may be similarly made/received as API calls.

At 408, the DPS 170 may validate the received certificate issued to an entity that operates the merchant processor 140 and/or the merchant. Such validation may be performed based on the digital certificate issued by the certificate generator 180. Upon validation, the DPS 170 may generate an order identifier that uniquely identifies the deferred RTP and identify the consumer bank 122 and consumer identifier that are stored in association with the consumer alias.

TABLE 3
Table 3 illustrates an example of a data structure that the DPS 170
may use to store generated order IDs, such as in the deferred RTP
database 103. Only three entries are illustrated for clarity.

| | | | Merchant | | | Current |
|---|---|---|---|---|---|---|
| Order | Full | Merchant | Processor | | Deferred | Order |
| ID | Amount | ID | ID | Consumer Alias | Flag | Closure Flag |
| 1 | 150.00 | 4321 | 9876 | joe[at]example[dot]com | 1 | 0 |
| 2 | 500.00 | 1111 | 2222 | 555-555-1234 | 1 | 0 |
| 3 | 250.00 | 0000 | 3333 | janeydoe | 0 | 0 |
| . . . | . . . | . . . | . . . | . . . | . . . | . . . |

As illustrated in Table 3, three order IDs 1-3 are generated and stored. Along with a respective: full amount, merchant ID and/or processor ID, consumer alias, and deferred flag. As illustrated, the deferred flag “1” indicates the RTP associated with order IDs 1 and 2 are to be deferred while the deferred flag “0” indicates the RTP associated with order ID 3 is not to be deferred and is to be paid immediately.

At 410, the DPS 170 may transmit, to the merchant processor 140, a response to the RTP message. The response to the RTP message may include the order identifier and the consumer alias.

At 412, the merchant processor 140 may transmit the order identifier and consumer alias to the merchant device 130.

At 414, the DPS 170 may look up the merchant name corresponding to the merchant identifier in the directory database 101 and transmit an RTP message to the consumer bank 122. The merchant name may be a name that is recognizable to a consumer and/or consumer bank 122. The RTP message may include the full amount, merchant name, a deferred flag set to indicate that a deferred RTP is to be made, unique account identifier associated with the consumer alias, the consumer alias, and the consumer identifier.

At 416, the consumer bank 122 may validate the consumer alias and the consumer identifier. For example, the consumer identifier may be issued by the consumer bank 122 to the consumer and the consumer may provide the consumer alias to the consumer bank 122 so that the consumer alias may be used in connection with payment transactions, including the deferred RTP.

At 418, the consumer bank 122 may transmit a notification to the consumer to confirm the request for the deferred RTP. For example, the consumer bank 122 may look up a communication mode such as an electronic mail address, phone number for SMS text, or banking application installed at the consumer device 120. The consumer bank 122 may then transmit the notification to confirm the request for the deferred RTP to the communication mode.

Referring now to FIG. 4B, at 420, the consumer device 220 may authenticate the consumer and transmit a result of the authentication to the consumer bank 122. For example, upon receiving the notification from the consumer bank 122, the consumer may launch the banking application on the consumer device 120 to logon and confirm the request for the deferred RTP. In connection with such logon, the banking application may authenticate the user through onboard biometric authentication, password or PIN-based authentication, and/or other authentication technique. In some examples, a result of the authentication is transmitted by the banking application to the consumer bank 122. In other examples, the authentication information such as password or PIN is transmitted to the consumer bank 122 for authentication.

At 422, responsive to consumer authentication, the consumer bank 222 may transmit, to the consumer device 120, the full amount and the merchant name for confirmation that the consumer requested the deferred RTP for the merchant identified by the merchant name.

At 424, the consumer device 120 may transmit, to the consumer bank 122, a confirmation of the request for the deferred RTP.

At 426, the consumer bank 122 may transmit, to the consumer device 120, a return confirmation of the request for the deferred RTP to acknowledge the confirmation.

At 428, the consumer bank 122 may transmit, to the DPS 170, a confirmation message that includes a deferred flag set to indicate that a deferred RTP is to be made, the order identifier, full amount, and the merchant name. The confirmation message may indicate that the full amount has been pre-authorized but has not been settled.

At 430, the DPS 170 may transmit, to the merchant processor 140, a payment confirmation may include a deferred flag set to indicate that a deferred RTP is to be made, the order identifier, and amount authorized (or declined).

At 432, the merchant processor 140 may transmit, to the merchant device 130, a payment notification message that indicates that the deferred RTP has been authorized (or declined).

At 434, the merchant device 130 may confirm the transaction with the consumer.

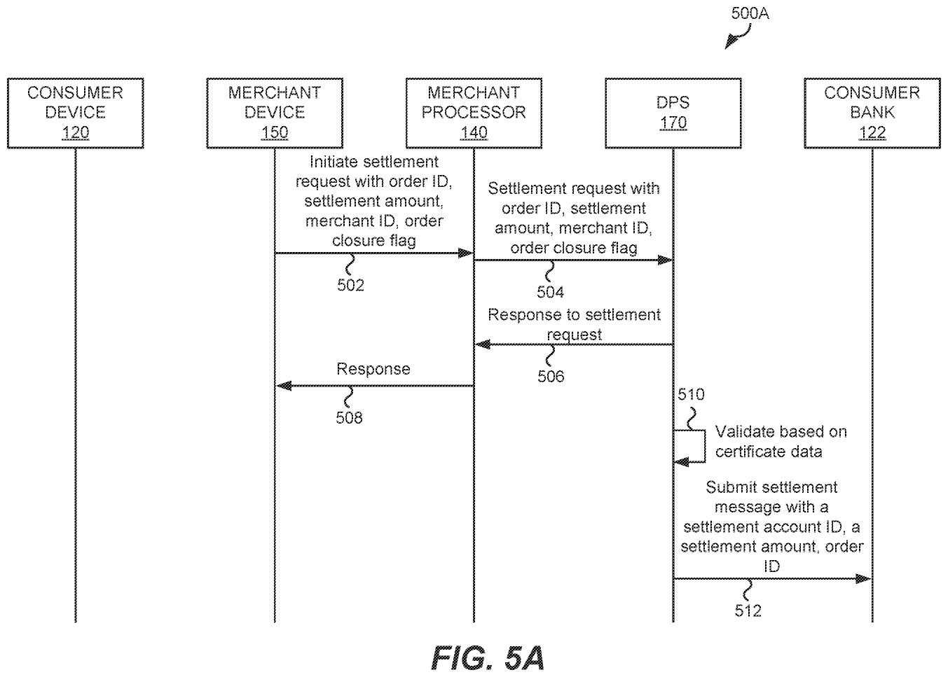

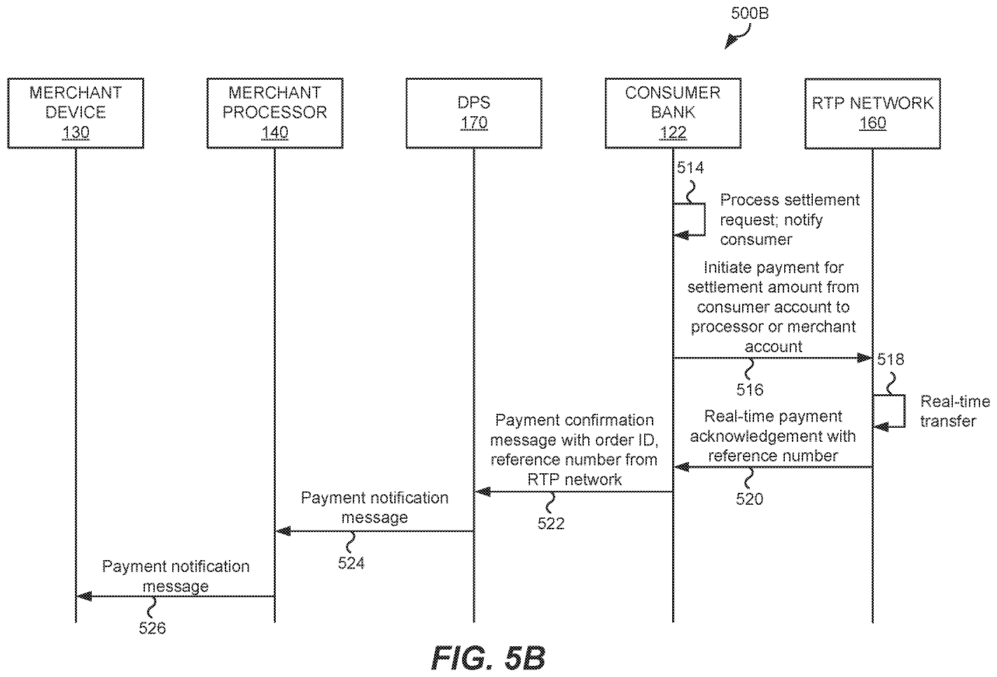

The deferred RTP generated in the examples of respective flow diagrams 400A and 400B illustrated in FIGS. 4A and 4B may be settled as one or more goods and/or services of a deferred fulfillment order are fulfilled, such as when a merchant ships an item and/or performs a service. An example of such settlement in the system environment 100 will now be described with reference to respective flow diagrams 500A and 500B of FIGS. 5A and 5B.

Referring first to FIG. 5A, at 502, the merchant device 130 may initiate a settlement request, to the merchant processor 140, when a portion or all of a deferred fulfillment order is fulfilled. The settlement request may include the order identifier, settlement amount, merchant identifier, and an order closure flag. The order closure flag. A settlement request may refer to a request to settle a portion or all of the total amount of the deferred fulfillment order for which a deferred RTP was generated. The settlement amount may vary based on whether a portion or all of the deferred fulfillment order is fulfilled. For example, the settlement amount may be all of the total amount of the deferred fulfillment order when the entire deferred fulfillment order has been fulfilled. The settlement amount may be a portion of the total amount of the deferred fulfillment order based on the proportional portion of the deferred fulfillment order that has been fulfilled. An order closure flag may refer to an indication of whether or not the deferred fulfillment order is closed and no further settlements after the current settlement amount are to occur. For instance, the merchant device 130 may set the order closure flag to indicate that the deferred fulfillment order identified by the order identifier is to be closed when the settlement amount and/or any prior settlement amounts for the deferred fulfillment order equals the total amount. Alternatively, or additionally, the merchant device 130 may set the order closure flag to indicate that the deferred fulfillment order identified by the order identifier is to be closed when all the goods and/or services of the deferred fulfillment order have been fulfilled. On the other hand, the merchant device 130 may set the order closure flag to indicate that the deferred fulfillment order identified by the order identifier is open when a balance remains on the total amount and/or when further goods and/or services are to be fulfilled. In some examples, the order closure flag may be a binary (yes/no) value such as a 1 (yes) or 0 (no) to indicate whether the deferred fulfillment order is closed.

At 504, the merchant processor 140 may transmit, to the DPS 170, the settlement request that includes the order identifier, the settlement amount, the merchant identifier, and the order closure flag.

At 506, the DPS 170 may transmit, to the merchant processor 140, a response to the settlement request, acknowledging receipt.

At 508, the merchant processor 140 may transmit the response that includes a settlement decision and order status to the merchant. Such transmission may be made to the merchant device 130 as shown and/or via another communication mode such as electronic mail to the merchant and/or the consumer.

At 510, responsive to the settlement request, the DPS 170 may validate the merchant processor based on digital certificate. The validation may be similar to the validation at 208 of FIG. 2A. In some examples, the consumer bank 122 may require the consumer to authenticate prior to transferring the settlement amount. Such authentication may be required under or subject to local regulatory requirements. In some examples, the authentication may be similar to the authentication at 220 of FIG. 2B.

At 512, the DPS 170 may transmit, to the consumer bank 122, a settlement message that includes a settlement account identifier (ID) identifying a settlement account, the settlement amount, and order identifier. The settlement account may refer to a bank account of a merchant processor 140 and/or a bank account of the merchant to which a bank account-to-bank account transfer is made from the consumer account via the RTP network 160. The DPS 170 may identify the settlement account of the merchant processor 140 and/or the merchant based on a pre-stored association of the settlement account with the merchant processor 140 and/or the merchant.

Referring now to FIG. 5B, at 514, responsive to the settlement message, the consumer bank 122 may process the settlement request. In some examples, the consumer bank 122 may notify the consumer of the settlement request based on a policy rule of the consumer bank. Such processing may include identifying the consumer account associated with the order identifier.

At 516, the consumer bank 122 may initiate payment for the settlement amount from the consumer account to the settlement account via the RTP network 160.

At 518, the RTP network 160 may transfer the settlement amount from the consumer account to the settlement account via real-time bank account-to-bank account transfer, which may occur in real-time such as in milliseconds.

At 520, the consumer bank 122 may receive, from the RTP network 160, a reference number acknowledging the RTP for the settlement amount.

At 522, the consumer bank 122 may transmit, to the DPS 170, a payment confirmation message with the order identifier and the reference number from the RTP network 160. The DPS 170 may store the order ID, the settlement amount, the order closure flag, and the reference number.

At 524, the DPS 170 may transmit, to the merchant processor 140, a payment notification message that indicates payment of the settlement amount.

At 526, the merchant processor 140 may forward, to the merchant device 130, the payment notification message.

TABLE 4
Table 4 illustrates an example of a data structure that the DPS 170
may use to store settlement amounts and order closure flags that
are set in the method illustrated by FIGS. 5A and 5B. Only three
entries are illustrated for clarity. The data structure illustrated
in Table 4 may be stored in the deferred RTP database 103.

| | Settlement | Order | Reference |
|---|---|---|---|
| Order ID | Amount | Closure Flag | Number |
| 1 | 50.00 | 0 | 102345 |
| 1 | 100.00 | 1 | 653241 |
| 2 | 250.00 | 1 | 989796 |
| . . . | . . . | . . . | . . . |

As illustrated in Table 4, order ID 1 includes two settlement amounts of 50.00 and 100.00 respectively. The method 300 may be invoked for each settlement amount. The first settlement amount of 50.00 was not the total amount of 150.00 for the order ID 1. The order closure flag is therefore set to indicate that the order ID 1 is to have further settlements (as indicated by the settlement request from the merchant processor 140). The second settlement amount of 100.00 completes the total amount of 150.00 for the order ID 1. Thus, the deferred RTP associated with Order ID 1 was settled using two settlement requests (two invocations of the method of FIGS. 5A and 5B) in the illustrated example of Table 4. On the other hand, Order ID 2 has been settled using a single settlement request. It should be noted that a given deferred RTP for a deferred order associated with as respective Order ID may be settled with any number of settlement requests depending on the number of shipments or service instances that are required to fully fulfill the deferred order.

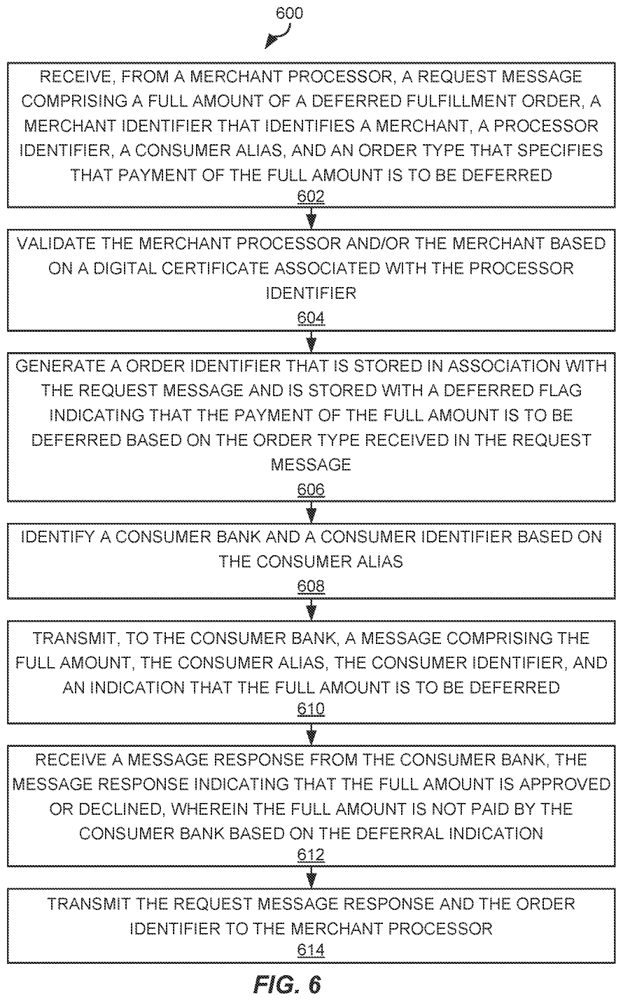

FIG. 6 illustrates an example of a method 600 of initiating an RTP via the RTP network 160.

At 602, the method 600 may include receiving, from a merchant processor 140 (such as the merchant processor 140), a request message. The request message may include a full amount of a deferred fulfillment order, a merchant identifier that identifies a merchant, a processor identifier, a consumer alias, and an order type that specifies that payment of the full amount is to be deferred.

At 604, the method 600 may include validating the merchant processor 140 and/or the merchant based on a digital certificate associated with the processor identifier.

At 606, the method 600 may include generating an order identifier that is stored in association with the request message and is stored with a deferred flag indicating that the payment of the full amount is to be deferred based on the order type received in the request message.

At 608, the method 600 may include identifying a consumer bank (such as consumer bank 122) and a consumer identifier based on the consumer alias.

At 610, the method 600 may include forwarding the request message to the consumer bank for authorization and an indication that the full amount is to be deferred. Forwarding may refer to transmitting the request message or a message based on the request message to the consumer bank.

At 612, the method 600 may include receiving a message response from the consumer bank. The message response may indicate that the full amount is approved or declined. Because the deferred indication was set to indicate that the full amount is to be deferred, the full amount is not paid by the consumer bank.

At 614, the method 600 may include transmitting the message response and the order identifier to the merchant processor 140.

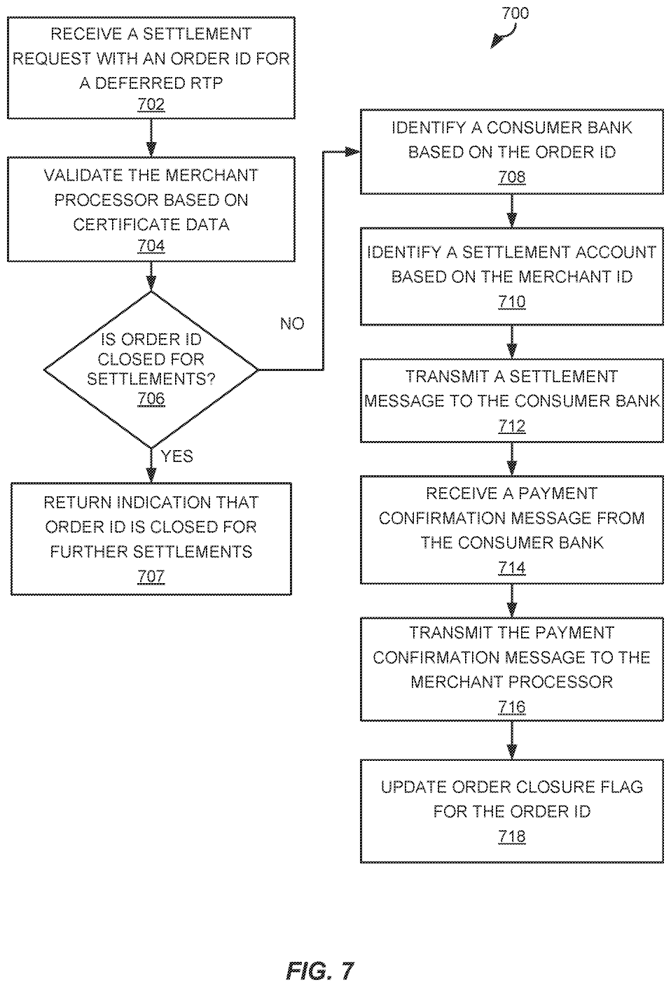

When the order ID is generated for the deferred RTP, the merchant may settle all or a portion of the full amount as the deferred fulfillment order is partially or fully fulfilled. For example, FIG. 7 illustrates an example of a method 700 of partially or fully settling a deferred RTP.

At 702, the method 700 may include receiving a settlement request that includes the order identifier, a settlement amount, and an order closure flag that indicates whether or not to permit further settlement requests for the order identifier. For example, if the order closure flag is set to “yes” or otherwise indicates that the deferred fulfillment order is to be closed, then no further settlements after this settlement request may be made in connection with the order identifier. Typically, this indicates that the merchant has fulfilled the entire deferred fulfillment order. On the other hand, if the order closure flag is set to “no” or otherwise indicates that the deferred fulfillment order is not to be closed, then further settlements may be made in connection with the order identifier. Typically, this indicates that the merchant has only partially fulfilled the entire deferred fulfillment order.

At 704, the method 700 may further include validating the merchant processor 140 and/or the merchant based on digital certificate. For example, the method 700 may authenticate the certificate as described with respect to the method 300 of FIG. 3.

At 706, the method 700 may include determining whether a current order closure flag indicates that the order identifier is closed for further settlements. The current order closure flag may indicate whether, before receipt of the settlement request, further settlements are permitted for the order identifier. For example, the method 700 may including consulting a data structured illustrated in Table 3 to determine the current order closure flag for the order identifier specified in the settlement request.

If the current order closure flag indicates that the order identifier is closed to further settlements, at 707, the method 700 may including returning an indication that the order identifier is closed for further settlements. It should be noted that the method 700 may further including verifying that the settlement amount plus any prior settlement amounts do not exceed the total amount for the order identifier.

If the current order closure flag indicates that the order identifier is closed to further settlements, at 708, the method 700 may include identifying a consumer bank based on the order identifier. For example, the method 700 may include consulting a data structure illustrated in Table 1 to identify the consumer bank. It should be noted that the consumer bank may be identified by a bank identifier such as a routing number instead of, or in addition to, the bank name illustrated in Table 1.

At 710, the method 700 may include identifying a settlement account based on the merchant identifier. For example, the method 700 may include consulting a data structure illustrated in Table 2 to identify the settlement account associated with the merchant identifier.

At 712, the method 700 may include transmitting, to the consumer bank 122, a settlement message that includes an identification of a settlement account, the settlement amount, and the order identifier.

At 714, the method 700 may include receiving, from the consumer bank 122, a payment confirmation message that includes the order identifier and a reference number from a real-time payment (RTP) network that transfers funds from the consumer account to the settlement account in real-time.

At 716, the method 700 may include transmitting, to the merchant processor 140, a payment notification based on the payment confirmation message.

At 718, the method 700 may include updating the current order closure flag based on the order closure flag from the received settlement request.

In some examples, the settlement amount (plus any prior settlement amounts) may be equal to the full amount for an order identifier. In these examples, typically the deferred fulfillment order has been completely fulfilled. In other examples, the settlement amount (plus any prior settlement amounts) is less than the full amount, in which case further settlements in connection with the order identifier may be made. For example, the method 700 may be repeated with a second settlement request, as well as any further settlement requests.

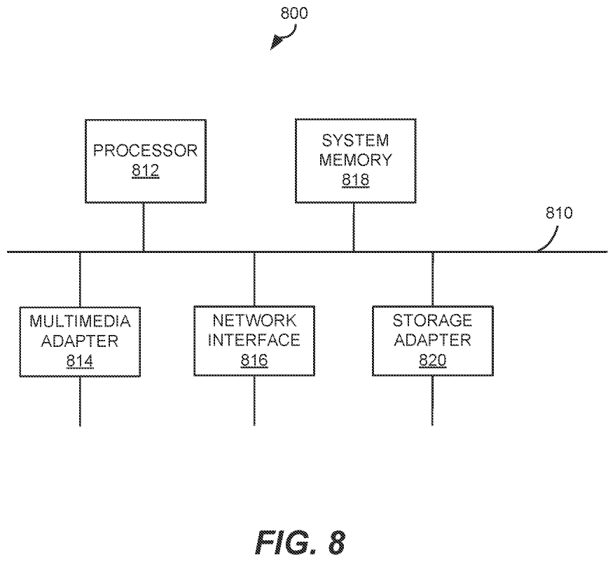

FIG. 8 illustrates an example of a computer system that may be implemented by devices illustrated in FIG. 1. Various ones of the devices of system environment 100 may be implemented based on some or all of the computer system 800. The computer system 800 may include, among other things, an interconnect 810, a processor 812, a multimedia adapter 814, a network interface 816, a system memory 818, and a storage adapter 820.

The interconnect 810 may interconnect various subsystems, elements, and/or components of the computer system 800. As shown, the interconnect 810 may be an abstraction that may represent any one or more separate physical buses, point-to-point connections, or both, connected by appropriate bridges, adapters, or controllers. In some examples, the interconnect 810 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 810 may allow data communication between the processor 812 and system memory 818, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 812 may control operations of the computer system 800. In some examples, the processor 812 may do so by executing instructions such as software or firmware stored in system memory 818 or other data via the storage adapter 820. In some examples, the processor 812 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 814 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 816 may provide the computer system 800 with an ability to communicate with a variety of remove devices over a network such as the communication network 111 illustrated in FIG. 1. The network interface 816 may include, for example, an Ethernet adapter, a Fibre Channel adapter, and/or other wired- or wireless-enabled adapter. The network interface 816 may provide a direct or indirect connection from one network element to another, and facilitate communication and between various network elements.

The storage adapter 820 may connect to a standard computer readable medium for storage and/or retrieval of information, such as a fixed disk drive (internal or external).

Other devices, components, elements, or subsystems (not illustrated) may be connected in a similar manner to the interconnect 810 or via a network such as the communication network 111. The devices and subsystems can be interconnected in different ways from that shown in FIG. 8. Instructions to implement various examples and implementations described herein may be stored in computer-readable storage media such as one or more of system memory 818 or other storage. Instructions to implement the present disclosure may also be received via one or more interfaces and stored in memory. The operating system provided on computer system 800 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number.

The databases described herein may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The components of the system environment 100 illustrated in FIG. 1 may be connected to one another via a communication network 111, which may include the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in the figures.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of deferred real-time payments (RTPs), comprising:
a deferred payment system, comprising a processor to:
receive, from a merchant processor, a request message comprising a full amount of a deferred fulfillment order, a merchant identifier that identifies a merchant, a processor identifier, a consumer alias, and an order type that specifies that payment of the full amount is to be deferred;
validate the merchant processor based on a digital certificate associated with the processor identifier;
generate an order identifier that is stored in association with the request message and is stored with a deferred flag indicating that the payment of the full amount is to be deferred based on the order type received in the request message;
identify a consumer bank and a consumer identifier based on the consumer alias;
transmit, to the consumer bank, a message comprising the full amount, the consumer alias, the consumer identifier, and an indication that the full amount is to be deferred;
receive a message response from the consumer bank, the message response indicating that the full amount is approved or declined, wherein the full amount is not paid by the consumer bank; and
transmit the message response and the order identifier to the merchant processor.

2. The system of claim 1, wherein the processor is further programmed to:
receive, from the merchant processor, a settlement request comprising the order identifier, a merchant identifier, a settlement amount, and an order closure flag that indicates whether or not to permit further settlement requests for the order identifier;
validate the merchant processor based on the digital certificate;
identify, based on the merchant identifier, a settlement account identifier that identifies a settlement account to which to make a real-time payment (RTP) from a consumer account;
transmit, to the consumer bank, a settlement message comprising the settlement account identifier, the settlement amount, and the order identifier;
receive, from the consumer bank, a payment confirmation message comprising the order identifier and a reference number from a real-time payment (RTP) network that transfers funds from the consumer account to the settlement account in real-time; and
transmit, to the merchant processor, a payment notification based on the payment confirmation message.

3. The system of claim 2, wherein the settlement amount is equal to the full amount and wherein the order closure flag comprises an indication that the full amount is satisfied.

4. The system of claim 2, wherein the settlement amount is less than the full amount, and wherein the processor is further programmed to:
receive, from the merchant processor, a second settlement request comprising the order identifier, the merchant identifier, a second settlement amount, and the order closure flag that indicates whether or not to permit further settlement requests for the order identifier;
validate the merchant processor based on the digital certificate;
identify, based on the merchant identifier, the settlement account identifier that identifies the settlement account to which to make the real-time payment (RTP) from the consumer account;
transmit, to the consumer bank, a second settlement message comprising the settlement account identifier, the settlement amount, and the order identifier;
receive, from the consumer bank, a second payment confirmation message comprising the order identifier and a second reference number from the RTP network that transfers funds from the consumer account to the settlement account; and
transmit, to the merchant processor, a second payment notification based on the second payment confirmation message.

5. The system of claim 1, wherein the processor is further programmed to:
receive, from the merchant processor, a request to register to use the system; and
provide the digital certificate to the merchant processor.

6. The system of claim 5, wherein the processor is further programmed to:
store the digital certificate in association with the merchant processor.

7. The system of claim 1, wherein the processor is further programmed to:
receive, from a consumer, a request to register to use the system, the request comprising the consumer identifier, the consumer alias, and the consumer bank of the consumer, the consumer identifier being assigned by the consumer bank; and
store the consumer alias in association with the consumer bank and the consumer identifier, the stored consumer alias being used to identify the consumer identifier without use of the consumer identifier.

8. A method of deferred real-time payments (RTPs), comprising:
receiving, by a processor of a deferred payment system, from a merchant processor, a request message comprising a full amount of a deferred fulfillment order, a merchant identifier that identifies a merchant, a processor identifier, a consumer alias, and an order type that specifies that payment of the full amount is to be deferred;
validating, by the processor, the merchant processor based on a digital certificate associated with the processor identifier;
generating, by the processor, an order identifier that is stored in association with the request message and is stored with a deferred flag indicating that the payment of the full amount is to be deferred based on the order type received in the request message;
identifying, by the processor, a consumer bank and a consumer identifier based on the consumer alias;
transmitting, by the processor, to the consumer bank, a message comprising the full amount, the consumer alias, the consumer identifier, and an indication that the full amount is to be deferred;
receiving, by the processor, a message response from the consumer bank, the message response indicating that the full amount is approved or declined, wherein the full amount is not paid by the consumer bank; and
transmitting, by the processor, the message response and the order identifier to the merchant processor.

9. The method of claim 8, further comprising:
receiving, by the processor, from the merchant processor, a settlement request comprising the order identifier, a merchant identifier, a settlement amount, and an order closure flag that indicates whether or not to permit further settlement requests for the order identifier;
validating, by the processor, the merchant processor based on the digital certificate;
identifying, by the processor, based on the merchant identifier, a settlement account identifier that identifies a settlement account to which to make a real-time payment (RTP) from a consumer account;
transmitting, by the processor, to the consumer bank, a settlement message comprising the settlement account identifier, the settlement amount, and the order identifier;
receiving, by the processor, from the consumer bank, a payment confirmation message comprising the order identifier and a reference number from a real-time payment (RTP) network that transfers funds from the consumer account to the settlement account in real-time; and
transmitting, by the processor, to the merchant processor, a payment notification based on the payment confirmation message.

10. The method of claim 9, wherein the settlement amount is equal to the full amount and wherein the order closure flag comprises an indication that the full amount is satisfied.

11. The method of claim 9, wherein the settlement amount is less than the full amount, the method further comprising:
receiving, by the processor, from the merchant processor, a second settlement request comprising the order identifier, the merchant identifier, a second settlement amount, and the order closure flag that indicates whether or not to permit further settlement requests for the order identifier;
validating, by the processor, the merchant processor based on the digital certificate;
identifying, by the processor, based on the merchant identifier, the settlement account identifier that identifies the settlement account to which to make the real-time payment (RTP) from a consumer account;
transmitting, by the processor, to the consumer bank, a second settlement message comprising the settlement account identifier, the settlement amount, and the order identifier;
receiving, by the processor, from the consumer bank, a second payment confirmation message comprising the order identifier and a second reference number from the RTP network that transfers funds from the consumer account to the settlement account; and
transmitting, by the processor, to the merchant processor, a second payment notification based on the second payment confirmation message

12. The method of claim 8, the method further comprising:
receiving, by the processor, from the merchant processor, a request to register to use the system; and
providing, by the processor, the digital certificate to the merchant processor.

13. The method of claim 12, the method further comprising:
storing, by the processor, the digital certificate in association with the merchant processor.

14. The method of claim 8, the method further comprising:
receiving, by the processor, from a consumer, a request to register to use the system, the request comprising the consumer identifier, the consumer alias, and the consumer bank of the consumer, the consumer identifier being assigned by the consumer bank; and
storing, by the processor, the consumer alias in association with the consumer bank and the consumer identifier, the stored consumer alias being used to identify the consumer identifier without use of the consumer identifier.

15. A system of settling a deferred real-time payment (RTP), comprising:
a processor programmed to:
receive, from a merchant processor, a first settlement request comprising an order identifier, a settlement amount, a merchant identifier, and an order closure flag that indicates whether or not to permit further settlement requests for the order identifier, the order identifier being stored in association with a consumer account;
validate the merchant processor based on a digital certificate associated with the merchant processor;
identify, based on the order identifier, a consumer bank;
identify, based on the merchant identifier, a settlement account identifier that identifies a settlement account to which to make a real-time payment (RTP) from the consumer account;
transmit, to the consumer bank, a settlement message comprising the settlement account identifier, the settlement amount, and the order identifier;
receive, from the consumer bank, a payment confirmation message comprising the order identifier and a reference number from an RTP network that facilitates the RTP for the settlement amount from the consumer account to the settlement account; and
transmit, to the merchant processor, a payment notification based on the payment confirmation message.

16. The system of claim 15, wherein the settlement amount is equal to a full amount of the deferred RTP and wherein the order closure flag comprises an indication that the full amount is satisfied.

17. The system of claim 16, wherein the settlement amount is less than the full amount, and wherein the processor is further programmed to:
receive a second settlement request comprising the order identifier, a second settlement amount, the merchant identifier, and a second order closure indication, the settlement amount plus the second settlement amount being equal to or less than the full amount;
validate the merchant processor based on the digital certificate;
identify, based on the order identifier, the consumer bank;
identify, based on the merchant identifier, the settlement account identifier;
transmit, to the consumer bank, a second settlement request comprising the settlement account identifier, the second settlement amount, and the order identifier;
receive, from the consumer bank, a second payment confirmation message comprising the order identifier and a second reference number from the RTP network that facilitates the RTP for the second settlement amount from the consumer account to the settlement account; and
transmit, to the merchant processor, a second payment notification based on the second payment confirmation message.

18. A merchant device of a merchant, comprising:
a processor to:
receive a request to initiate a deferred real-time payment (RTP) via a real-time payment network that facilitates direct transfer of funds between bank accounts in real-time, the request comprising a consumer alias, a full amount to be paid, and an indication to defer payment of the full amount, wherein the consumer alias is associated with but does not include an identification of a consumer bank that is to transfer funds to a merchant bank for the deferred RTP;
generate a message comprising the full amount, the consumer alias, a merchant identifier that identifies the merchant, and a deferral indication to defer payment of the full amount;
transmit the message to a merchant processor that processes payments on behalf of the merchant;
receive, from the merchant processor, a message response comprising an order identifier;
store the order identifier in association with the deferred RTP; and
receive, from the merchant processor, a confirmation message comprising the order identifier and an approval amount.

19. The merchant device of claim 18, wherein the processor is further to:
receive an indication that only a portion of one or more goods or services associated with the deferred RTP has been fulfilled by the merchant;
identify a first settlement amount that is less than the full amount based on the portion;
generate a first settlement request comprising the order identifier, the first settlement amount, the merchant identifier, and an order closure flag having a first value that indicates that the deferred RTP is not to be fully settled and closed;
transmit the first settlement request to the merchant processor; and
receive a response to the first settlement request from the merchant processor.

20. The merchant device of claim 19, wherein the processor is further to:
receive an indication that a final portion of the one or more goods or services has been fulfilled by the merchant;
identify a second settlement amount that is less than the full amount based on the final portion;
generate a second settlement request comprising the order identifier, the second settlement amount, the merchant identifier, and the order closure flag having a second value that indicates that the deferred RTP is to be fully settled and closed;
transmit the second settlement request to the merchant processor; and
receive a second response to the second settlement request from the merchant processor.
